(19) United States
(12) Patent Application Publication
(10) Pub. No.: US 2003/0002193 A1
(43) Pub. Date: Jan. 2, 2003

(54) Method of providing a programmable voltage bias during multi channel servo mode

(76) Inventor: Echere Iroaga, Scarborough (CA)

Correspondence Address: TEXAS INSTRUMENTS INCORPORATED, P O BOX 655474, M/S 3999, DALLAS, TX, 75265

(21) Appl. No.: 10/150,662

(22) Filed: May 17, 2002

Related U.S. Application Data
(60) Provisional application No. 60/301,997, filed on Jun. 28, 2001.

(51) Int. Cl. G11B 5/03

(52) U.S. Cl. 360/66

(57) ABSTRACT

A circuit to voltage bias a first head to access a disk includes a circuit to bias the head with said voltage, a feedback circuit to measure the voltage and generate a feedback signal to correct deviations in the voltage, and a switch circuit to switch the feedback circuit to a serial head while maintaining the feedback head or said first head.

### FIELD OF THE INVENTION

The present invention relates to disk circuits and more particularly to a method and apparatus for reading information and writing information to and from a magnetic disk.

### BACKGROUND OF THE INVENTION

When a head is voltage biased, this voltage bias requires a feedback loop to assure that the correct voltage bias is applied to the head to avoid too high a voltage being applied to the head. One method of achieving the voltage bias is by biasing the head with a current across a resistor and then using a feedback loop to measure the voltage drop across the resistor and correspondingly adjusting the current. However, during multi channel servo operation, multiple heads are selected that vary in resistance value. With MR heads, the resistor across the head is designed by R_{MR}. Associated with the MR head is a separate write head. If one head has a particularly low resistance R_{MR}, this low resistance would cause the feedback loop to increase the bias current and stress the other heads having a higher resistance R_{MR}. Consequently, it is necessary to control the feedback loop during multi channel servo operation to provide an accurate feedback. With the prior art, the feedback circuit is connected to all the heads in parallel so that each head receives the same feedback.

In a multi head environment, not all the head locations have a physical head mounted. In such case, if a head is mounted, such a head is called a populated head, and the missing head locations are called a unpopulated head. A typical servo sequence is as follows, the disk drive is operating in read mode on a selected populated head. This populated head has been selected by the select decode circuit. A switch to servo read mode is desired. All fault circuits such as reader open circuits and short fault circuits are disabled. The select decode circuit is still enabled to select a single channel read head. The serial port select code which is connected to the select decode circuit is switched to prepare for servo write. The serial port is set to the appropriate value for multi-head select decode to prepare for a multi channel operation. The disk system is switched into servo write mode. The select channel decode circuit is enabled, and multiple heads are selected. Write mode is enabled. To switch back to servo read for single channel, the select decode circuit is enabled for single channel operation. The serial port select bits are switched to select the required single channel head. The circuit is switched out of servo read mode. As discussed above, unpopulated head positions are open heads which introduce large amounts of error to the feedback. It is further possible that the decoder circuit can obtain an invalid single code address from the fact that the head is not populated. Consequently, the feedback is incorrect.

It is known to include servo information on some of the tracks and to provide servo transducer heads for reading such information to enable control of the lateral position of the head assembly thereby dynamically maintaining the respective transducer elements of the head assembly relative to the tracks.

In the embedded servo type system, servo information or servo bursts are recorded on data tracks which also contains stored data. The servo bursts are typically temporarily spaced evenly about the circumference of each data track. Data is recorded on a data track between the servo bursts. In an dedicated servo type systems, the entire disk service in a disk drive is dedicated to storing the servo information.

As the data head reads the servo information, the transducer provides a position signal which is decoded by the position modulator and is presented in digital form to a servo control processor. The servo control processor essentially compares actual radial position of the transducer over the disk (as indicated by the embedded servo burst) with a desired position and commands this actuator to move in order to minimize position error.

The servo information is written on the disk surfaces during manufacturer of the disk drive module. Each disk module is mounted to a servo writer support assembly which properly locates the disk surfaces relative to the reference or origin. The servo writer support assembly supports a position sensor such as a laser light interferometer meter which detects the position to the actuator relative to the disk surfaces. The position sensor is electronically inserted within the disk drives negative feedback, closed loop servo system for providing position information to the servo system while the servo data was being written to the disk surfaces. The servo writer support position assembly may also support a clock writer transducer which writes a clock pattern onto disk surface.

FIG. 1 illustrates a circuit that controls the head selection as well as the feedback circuit with a common signal. The heads selection determines the feedback. It is impossible to separate the head from the feedback.

### SUMMARY OF THE INVENTION

With the present invention, the feedback for the read head is always based upon a selected read head, and for example, head 0 could be chosen as feedback head even though another head is actually selected manufacturers. Consequently an accurate value of the feedback can be obtained. However, R_{MR} value can vary between 30 ohms to 150 ohms. The present invention may use the lowest R_{MR} value for feedback. Thus, the present invention protects all the heads from feedback values which are inaccurate. Additionally, the present invention provides for a serial port control of the feedback so that the head with the lowest resistance or any other head can be select for feedback. Thus, with the present invention under multi channel mode, the feedback is based upon a single head which has been pre-selected.

### BRIEF DESCRIPTION OF THE DRAWINGS

FIG. 1 illustrates a voltage bias circuit and feedback circuit;

FIG. 2 illustrates a bias circuit and feedback circuit of the present invention;

FIG. 3 illustrates a signal diagram of the present invention;

FIG. 4 is a side view of a disk drive system; and

FIG. 5 is a top view of a disk drive system.

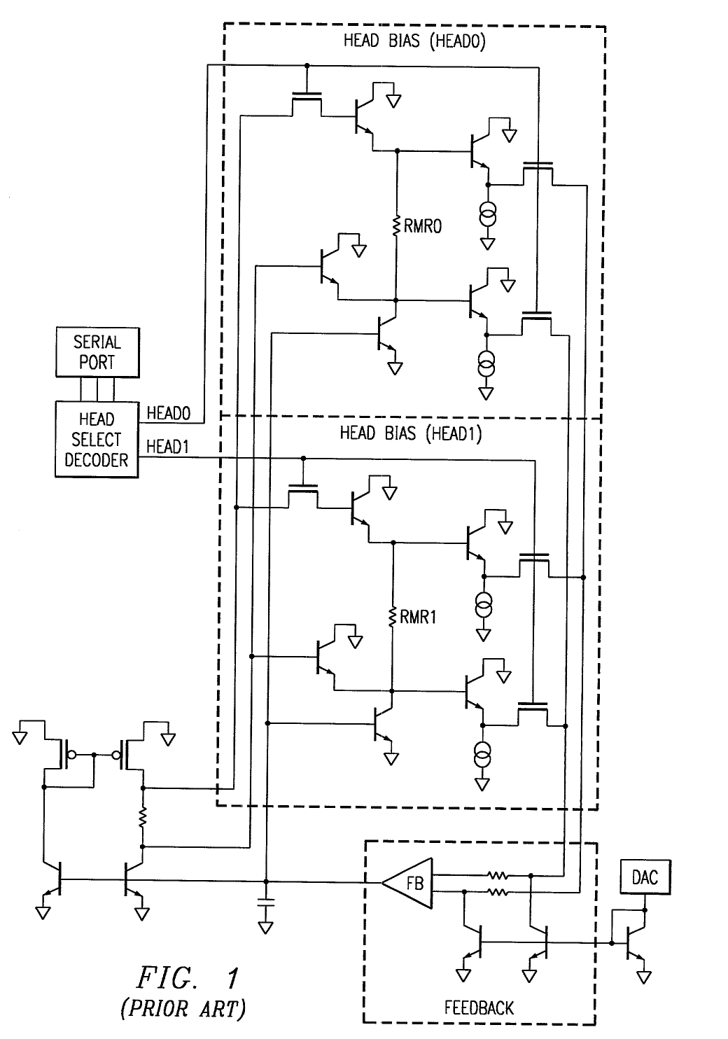

### DETAILED DESCRIPTION OF THE DRAWINGS

The following invention is described with reference to figures in which similar or the same numbers represent the same or similar elements. While the invention is described in terms for achieving the invention's objectives, it can be appreciated by those skilled in the art that variations may be accomplished in view of these teachings without deviation from the spirit or scope of the invention.

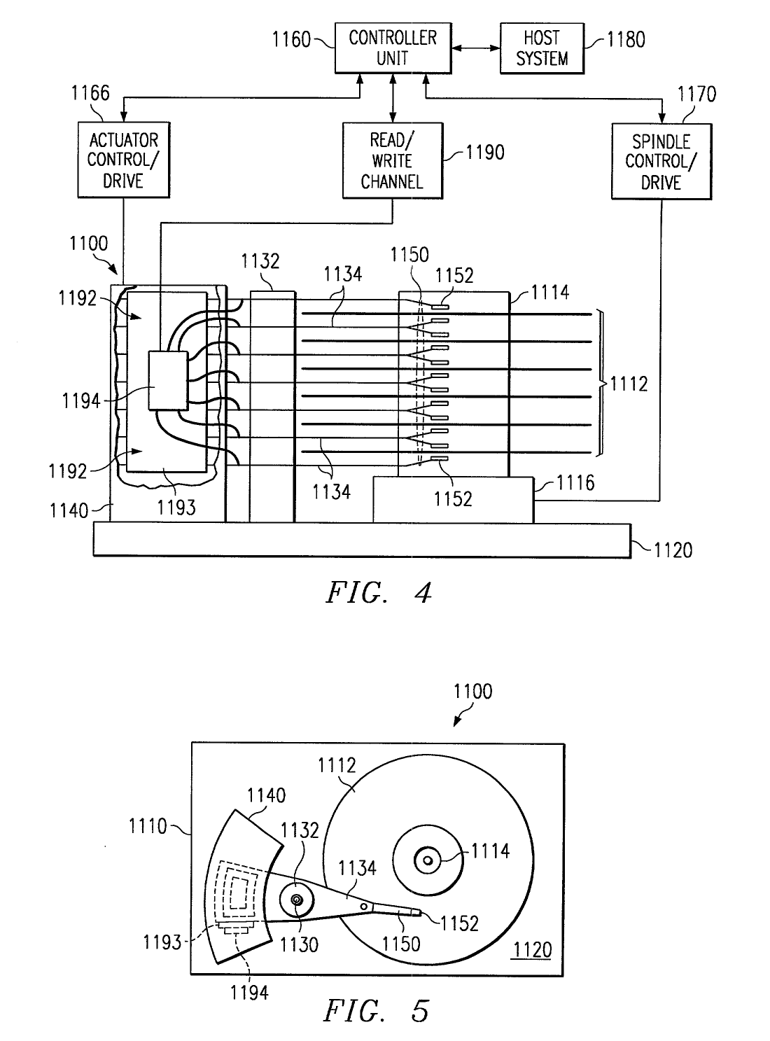

FIGS. 4 and 5 show a side and top view, respectively, of the disk drive system designated by the general reference 1100 within an enclosure 1110. The disk drive system 1100 includes a plurality of stacked magnetic recording disks 1112 mounted to a spindle 1114. The disks 1112 may be conventional particulate or thin film recording disk or, in other embodiments, they may be liquid-bearing disks. The spindle 1114 is attached to a spindle motor 1116 which rotates the spindle 1114 and disks 1112. A chassis 1120 is connected to the enclosure 1110, providing stable mechanical support for the disk drive system. The spindle motor 116 and the actuator shaft 1130 are attached to the chassis 1120. A hub assembly 1132 rotates about the actuator shaft 1130 and supports a plurality of actuator arms 1134. The stack of actuator arms 1134 is sometimes referred to as a “comb.” A rotary voice coil motor 1140 is attached to chassis 1120 and to a rear portion of the actuator arms 1134.

A plurality of head suspension assemblies 1150 are attached to the actuator arms 1134. A plurality of inductive transducer heads 1152 are attached respectively to the suspension assemblies 1150, each head 1152 including at least one inductive write element. In addition thereto, each head 1152 may also include an inductive read element or a MR (magneto-resistive) read element. The heads 1152 are positioned proximate to the disks 1112 by the suspension assemblies 1150 so that during operation, the heads are in electromagnetic communication with the disks 1112. The rotary voice coil motor 1140 rotates the actuator arms 1134 about the actuator shaft 1130 in order to move the head suspension assemblies 1150 to the desired radial position on disks 1112.

A controller unit 1160 provides overall control to the disk drive system 1100, including rotation control of the disks 1112 and position control of the heads 1152. The controller unit 1160 typically includes (not shown) a central processing unit (CPU), a memory unit and other digital circuitry, although it should be apparent that these aspects could also be enabled as hardware logic by one skilled in the computer arts. Controller unit 1160 is connected to the actuator control/drive unit 1166 which is in turn connected to the rotary voice coil motor 1140. A host system 1180, typically a computer system or personal computer (PC), is connected to the controller unit 1160. The host system 1180 may send digital data to the controller unit 1160 to be stored on the disks, or it may request that digital data at a specified location be read from the disks 1112 and sent back to the host system 1180. A read/write channel 1190 is coupled to receive and condition read and write signals generated by the controller unit 1160 and communicate them to an arm electronics (AE) unit shown generally at 1192 through a cut-away portion of the voice coil motor 1140. The AE unit 1192 includes a printed circuit board 1193, or a flexible carrier, mounted on the actuator arms 1134 or in close proximity thereto, and an AE module 1194 mounted on the printed circuit board 1193 or carrier that comprises circuitry preferably implemented in an integrated circuit (IC) chip including read drivers, write drivers, and associated control circuitry. The AE module 1194 is coupled via connections in the printed circuit board to the read/write channel 1190 and also to each read head and each write head in the plurality of heads 1152. The AE module 1194 includes the head circuit of the present invention.

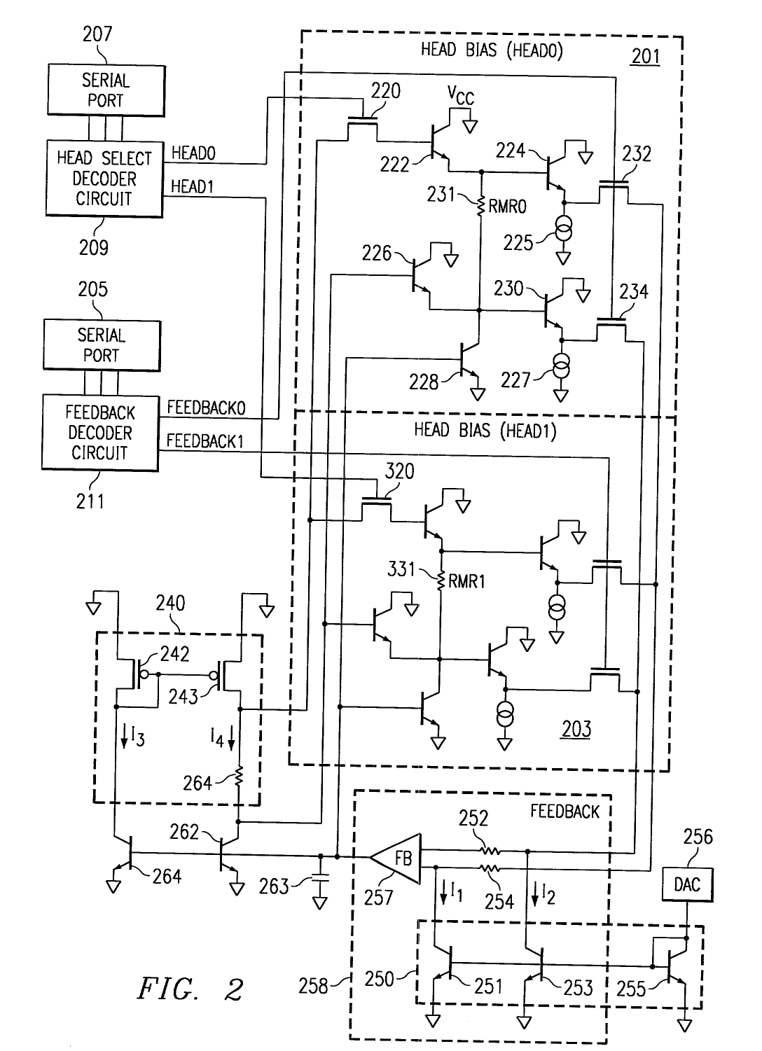

FIG. 2 illustrates a circuit to bias the head of the present invention. Circuit 201 is a head voltage bias circuit for head 0. Head 0 being represented by resistor 231, R_{MR}. It is to be understood that although a magnetic resistive head is illustrated; a write head is also intended to be illustrated by resistor 231. Additionally, FIG. 2 illustrates a head voltage bias circuit 203 for head 1 which is similar to head bias circuit 201 except a different head (heads) is bias. FIG. 2 illustrates a feedback circuit 258 to provide feedback to the head voltage bias circuit 201 and 203. Additionally, FIG. 2 illustrates a head decoder circuit 209 and feedback decoder circuit 211. The head bias circuit 201 includes a switch, for example a FET 220, a transistor 222 having a base connected to the drain of FET 220. The collector of transistor 222 is connected to voltage V_{CC} while the emitter of transistor 222 is connected to the read write head 231 having resistance R_{MR}. The head 231 illustrated by a resistor having the resistance of the R_{MR} head has another end connected to the emitter of transistor 226. The collector of transistor 226 is connected to voltage V_{CC} while the base of transistor 226 is connected to the collector of transistor 262. The FET 220 acts as a switch to select this head based upon a signal from the head select decode circuit 209. The emitter of transistor 222 is additionally connected to the base of transistor 224. The collector of transistor 224 is connected to voltage V_{CC} while the emitter of transistor 224 is connected to FET 232 or switch 232 and additionally connected to a current source 225. The other end of read/write head 231 is connected to the base of transistor 230. The collector of transistor 230 is connected to voltage V_{CC} while the emitter of transistor 230 is connected to the current source 227. Additionally, the emitter of transistor 230 is connected to the source of FET 234. The FETs 232 and 234 act as switches to selectly disconnect and connect the feedback circuit 258 from controlling the voltage of the read/write head for example, here, head 231. The gate of FET 232 and FET 234 are connected together and connected to the feedback decoder circuit 211. The feedback decoder circuit 211 selectly activates these switches 232 and 234 to engage the feedback circuit for this head. Transistor 224 operates as a switch that connects the linear amplifier 256 with the head 231. Transistor 230 or switch 230 performs the same function as transistor 224 to connect the feedback linear amplifier 256 with the head 231. The FET 220 acts as a head switch to control which head is being bias. Transistor 222 and transistor 226 supply a bias voltage to head 231 to supply voltage across the head 231. Transistor 228 provides a path for bias current through the head 231. The feedback circuit 258 includes a feedback linear amplifier 256. In addition, a DAC circuit which is digital to analog converter 250 provides current through transistor to 255 from the collector of transistor 225 to the emitter of transistor 225, which is connected to ground. The base of transistor 225 is connected to the collector of transistor 225 to form a current mirror with transistor 251 and 253. The DAC circuit 256 supplies a current to the transistor 255 and this current is mirrored to the first current path I₁ through to the collector and emitter of transistor 251 and second current path I₂ through collector and emitter of transistor 253. The base of transistor 253 is connected to the base of transistor 255, and the base of transistor 251 is connected to the base of transistor 255. The emitter of transistor 251 is connected to ground and the emitter of transistor 253 is connected to ground. The collector of transistor 251 is connected between the feedback linear amplifier 256 and the resistor 254. The collector of transistor 253 is connected between the resistor 252 and the FET 243. The DAC circuit 256 controls the current flowing in a transistor 251 and transistor 253. Correspondingly, the current flowing in transistor 251 and transistor 253 control the differential voltage drop across resistors 252 and 254. As the current increases in transistor 251 and transistor 253, the voltage drop between transistor 252 and 254 is reduced. Thus, the difference in voltage between transistor 224 and 230 are correspondingly reduced. Since the output of feedback linear amplifier 256 depends on the difference in voltage at its inputs, the output of linear feedback circuit 256 is correspondingly reduced. The resistor 252 is connected to one input of the feedback linear amplifier 256 and the other input of feedback linear amplifier 256 is connected to resistor 252. The output of feedback linear amplifier is connected to, capacitor 263, transistor 262, and transistor 264 by virtue of the connection of the linear feedback amplifier 256 to the base of transistor 262 and 264. The current which is output from feedback linear amplifier 256 is converted to a voltage by capacitor 263 and thus this capacitor voltage formed on capacitor 263 controls transistor 262 and transistor 264. The collector and emitter of transistor 264 form a third current path I₃ and collector and base of transistor 262 form a fourth current path I₄. Transistor 262 and transistor 264 are connected to different current paths (I₃ and I₁) of current mirror 240. PFET 242 and PFET 243 are shown illustrating the current mirror 240. The collector of transistor 262 is connected to the base of transistor 226. The collector of transistor 262 is connected to resistor 264. The feedback decoder circuit 210 controls which head the feedback is to be used from. Serial port 205 controls the feedback decode circuit 211. To input a head number such as head 0. A code could be input to the serial port 205 for even number heads, all the head; or any particular head. The serial port 205 could select the head that has the lowest resistance of the MR head. The last head selected in the single channel read mode could be used.

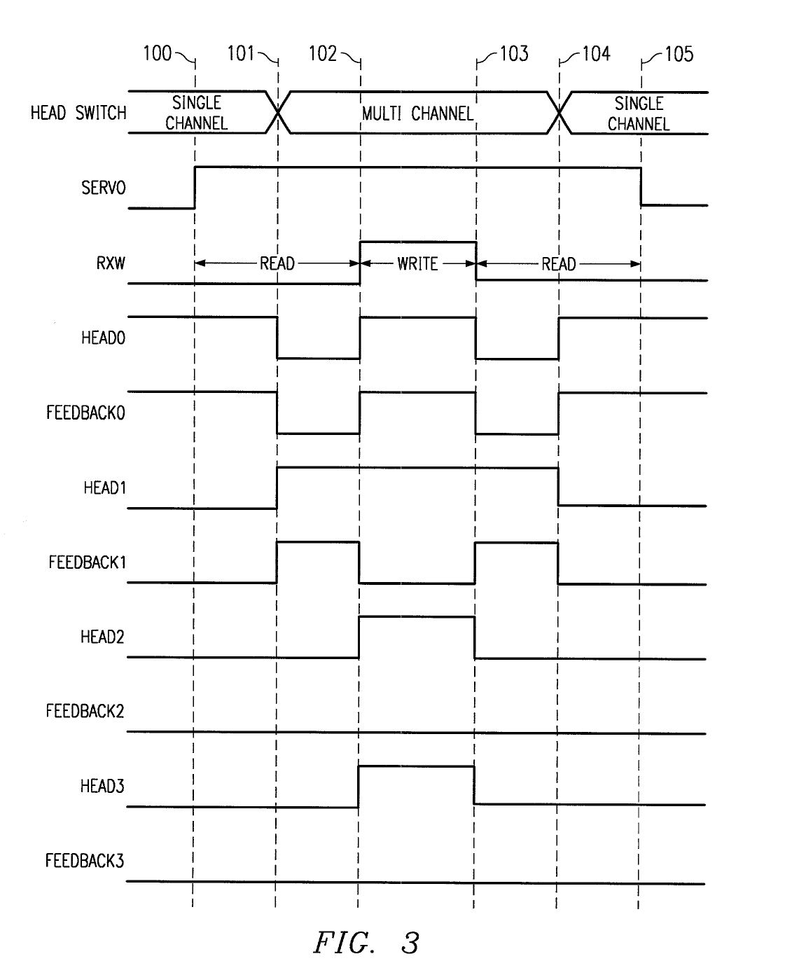

FIG. 3 illustrates a timing diagram showing the feedback from specific heads used on conjunction with the present invention.

In operation, assuming that head 0 is selected to have the feedback of head 0 applied to either head 1 designed by head 231. Head 1 could have been selected to have the feedback of head 0 applied to head 1.

The head select circuit 209 activates switch 220, and the feedback select circuit 211 activates switch 232 and switch 234. The feedback from head 0 (head 231) is applied to the operation of head 231.

The head select circuit 209 activates switch 320. The feedback select circuit 211 continues to activate switch 232 and switch 234. The feedback from head 0 (head 231) is applied to the operation of head 231 (head 1).

The feedback of any head could be applied to any head.

At time 101 when the head switch is changing from single channel to multi channel, head 1 is selected and addition feedback 1 is selected. At time 102 when the write sequence starts the feedback from head 1 seizes and the feedback from head 0 begins. At time period 103 when the write had ended the feedback from head 0 is turned off and the feedback from head 1 is activated. At time period 104 the multi channel ends and the single channel period begins and feedback from head 0 is activated.

1. A circuit to voltage bias a first head to access a disk; comprising:
a circuit to bias said first head with a voltage;
a feedback circuit to measure said voltage and generate a feedback signal to correct deviations in said voltage; and
a switch circuit to switch said feedback circuit to a second head while maintaining said feedback based as said first head.

2. A circuit to voltage bias as in claim 1, wherein said switch circuit includes a feedback decode circuit to switch said feedback circuit.

3. A circuit to voltage bias as in claim 2, wherein said feedback decode circuit includes a serial port to enter a code for said feedback decode circuit to select said first head or said second head for feedback.

4. A circuit to voltage bias as in claim 2, wherein said switch is operable to switch the feedback from a plurality of feedback circuits.
